(19) United States
(12) Patent Application Publication
(10) Pub. No.: US 2021/0281646 A1
(43) Pub. Date: Sep. 9, 2021

(54) METHODS, SYSTEMS, AND APPARATUSES FOR VOICE RESTORATION FOR ORIGINATING CALLS

(71) Applicant: Comcast Cable Communications, LLC, Philadelphia, PA (US)

(72) Inventors: Matthew J. CHRISTOPHER, Highlands Ranch, CO (US); Raghavendra P. HEGDE, Wayne, PA (US)

(21) Appl. No.: 16/808,218

(22) Filed: Mar. 3, 2020

(51) Int. Cl. H04L 29/08; H04L 29/06; H04L 9/14; H04L 29/12

(52) U.S. Cl. CPC H04L 67/14; H04L 61/2007; H04L 9/14; H04L 69/22

(57) ABSTRACT

Systems and methods are described herein for call processing. A failed call attempt with a primary network computing device may be restored by a secondary network computing device. The call may be restored without disconnecting the call session or requiring the call originator to be registered with the secondary network computing device. Restoration information may be placed at various network computing devices in a system to restore failed calls. The restoration information may comprise data associated with a user registration. The secondary network computing device may receive the restoration information when the primary network computing device is not responding. The secondary network computing device may process the call.

### BACKGROUND

Voice calls or other communications may occasionally fail. A device that is initiating a voice call may lose the call when the network computing device to which the call is routed is not responding (e.g., unreachable). The network computing device may not respond for reasons including but not limited to a maintenance cycle, a software failure, or a hardware failure. Network issues may also cause the network computing device to not respond. The network computing device may also have lost user registration data due to a restart. Accordingly, there is a need for improved call restoration techniques to enable a call to be processed by a secondary network computing device when a primary network computing device is not responding.

### SUMMARY

Systems and methods are described herein for call processing. The calls may be processed in a Voice Over Internet Protocol (VoIP) system. Calls may be restored following failed attempts without disconnecting the call session. According to the techniques described herein, restoration information may be placed at various network computing devices in the system. The restoration information may comprise data associated with a user registration. A secondary network computing device may receive the restoration information when a primary network computing device, that was originally requested to route a call requested by the user, is not responding. The secondary network computing device may process the call so that the call is not disconnected when the primary network computing device is unreachable. Future calls originated by the user may then be processed by the secondary network computing device.

### BRIEF DESCRIPTION OF THE DRAWINGS

The following drawings show generally, by way of example, but not by way of limitation, various examples discussed in the present disclosure. In the drawings:

FIG. 1 is an example call flow;

FIG. 2 is an example call flow;

FIG. 3 shows an example system for VoIP services;

FIG. 4 is an example call flow;

FIG. 5 is an example call flow;

FIG. 6 is an example call flow;

FIG. 7 is an example call flow;

FIG. 8 shows an example method;

FIG. 9 shows an example method;

FIG. 10 shows an example method; and

FIG. 11 shows an example computing device.

### DETAILED DESCRIPTION OF ILLUSTRATIVE EMBODIMENTS

Systems and methods are described herein for processing calls in a calling system. The techniques described herein restore failed call attempts without disconnecting the call (also referred to as call teardown or clearing). The restoration technique described herein enables a user's failed call to be restored by a secondary network computing device prior to that user registering with the secondary network computing device. Information may be placed at various network computing devices in the system that enables one or more of the network computing devices to restore the call. The information may be referred to herein as restoration information, and the restoration information may be proactively placed at network computing devices. The restoration information may enable a secondary network computing device to restore a call when a primary network computing device, which is originally requested to connect the call, does not respond to a message for call initiation. For example, the primary network computing device may be inoperable (e.g., following an unreachable event experienced by the primary network computing device).

The restoration information may comprise data associated with a request from a user computing device to establish a call. The data associated with the request may comprise user registration data so that the secondary network computing device may register the user, connect the call following the unreachable primary network computing device event, and connect future calls from that user. The user registration data may comprise at least one of an IP Multimedia Public Identity (IMPU), a contact IP address, or timing information indicating at least one of when a user registered or an amount of time that the user registration data is valid (e.g., a timestamp and registration window).

For security and privacy, at least a portion of the restoration information may be optionally encrypted. The restoration information may comprise encrypted contents such as the data that is unique to the user registration. A security-key may be installed on the network computing devices in the system. The security-key may be used to encrypt and decrypt contents of the restoration information. One of several security-key mechanisms may be leveraged to ensure that the initiator and the recipient have a trusted relationship. Security-key mechanisms may comprise at least one of a symmetric encryption based common key that is shared across all network computing devices (enabling encryption and decryption with the same key), an asymmetric encryption based public and private key combination, or a Java web token (JWT).

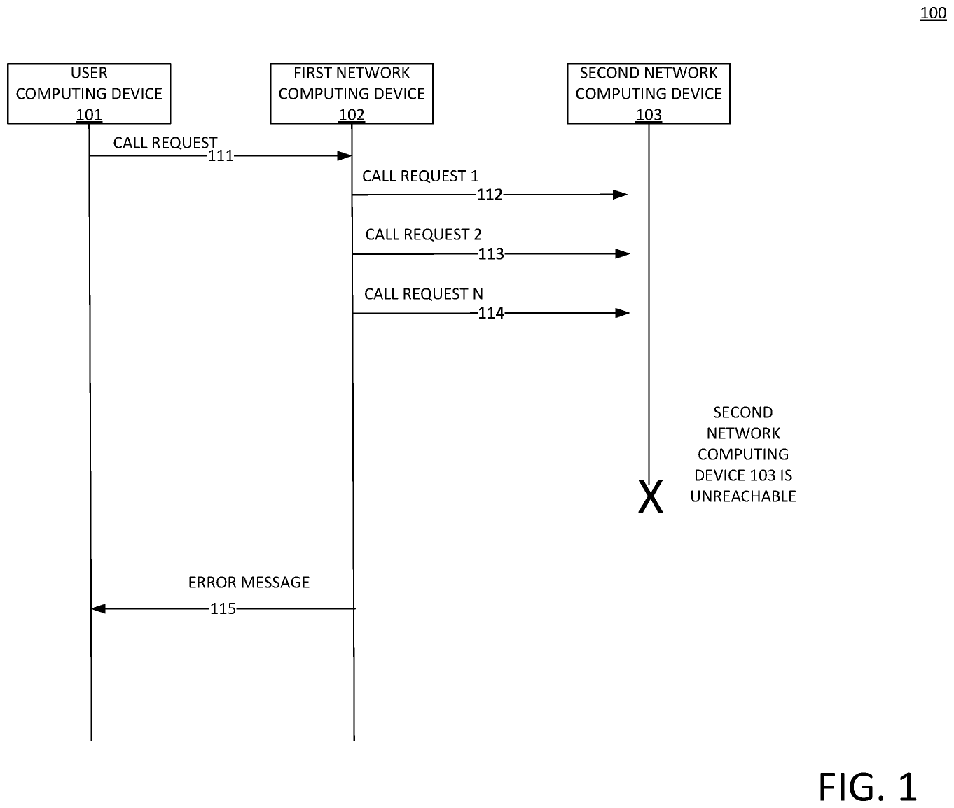

FIG. 1 is an example call flow diagram 100 of a failed originating call attempt without an originating call restoration technique. At step 111, a user computing device 101 may send a message comprising a request to establish a call to a first network computing device 102 and at the same time may initiate its re-registration timer. The message may be initiated when, for example, the user picks up a telephone connected to the user computing device 101 and dials digits to initiate a call. When the re-registration timer expires, the user computing device 101 registers with another network computing device. At step 112, the first network computing device 102 may initiate a timer and send a call request message to a second network computing device 103, which is the network computing device to which the user computing device 101 is registered. When the timer initiated by the first network computing device 102 expires, the first network computing device 102 considers the second network computing device 103 to be unreachable (e.g., an unreachable event occurred). At step 113, the first network computing device 102 may send another call request message to the second network computing device 103. At step 114, the first network computing device 102 may continue sending N call request messages until its timer expires. At step 115, the first network computing device 102 may send an error message to the user computing device 101 to indicate that the call failed. In this scenario, for the period following the second network computing device 103 failure but before the user computing device 101 re-registration timer expires, the user's first originating call attempt has failed (steps 111 through 116).

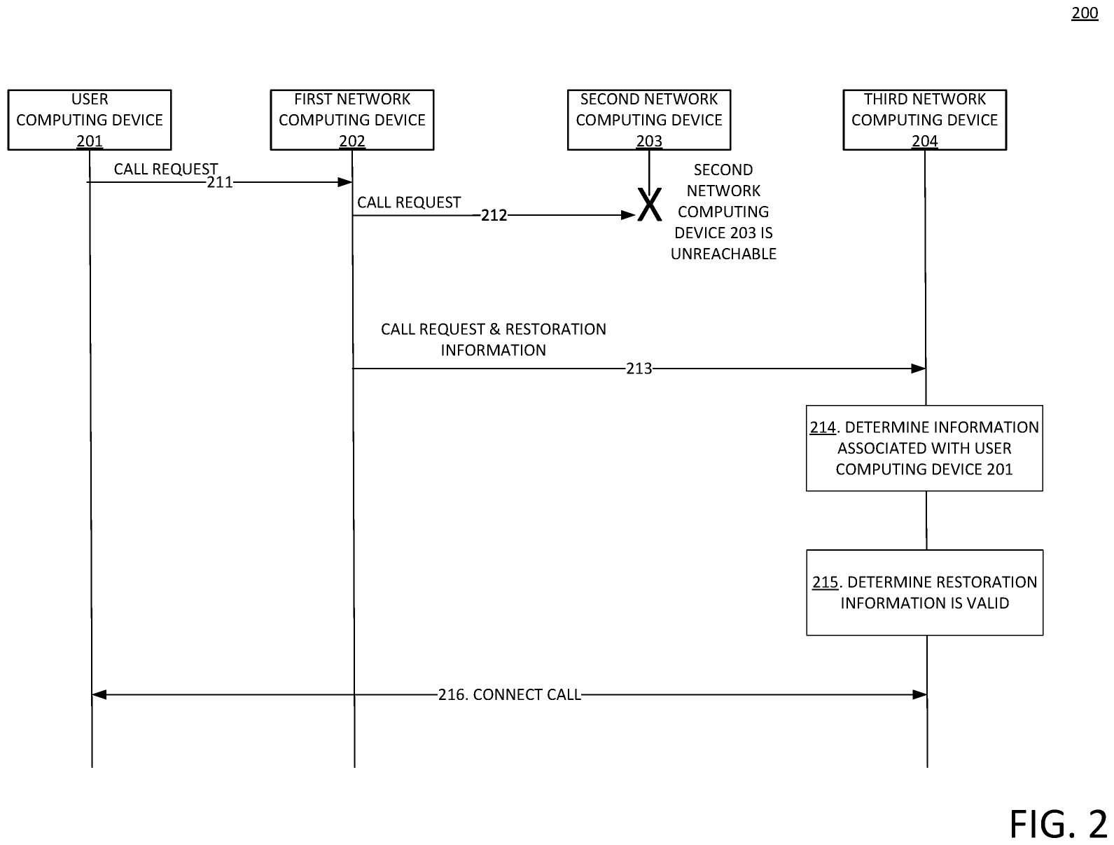

FIG. 2 is an example call flow diagram 200 showing an originating call being restored using the restoration techniques described herein enabled. At step 211, a user computing device 201 may send a message comprising a request to establish a call to a first network computing device 202. The message may be initiated when, for example, the user picks up a telephone connected to the user computing device 201 and dials digits to initiate a call. At step 212, the first network computing device 202 may route the message to a second network computing device 203, which is configured to serve requests from the user computing device 201. The first network computing device 202 may determine that the second network computing device 203 is not responding to the message. For example, the second network computing device 203 may be unreachable.

At step 213, the first network computing device 202 may send the message comprising the request to establish the call and the restoration information to a third network computing device 204 in the system. The restoration information may be inserted by the first network computing device 202 into a header (e.g., a restoration-header) in the message. A portion of the restoration information may be optionally encrypted. When the restoration information is encrypted, prior to call initiation, a security-key may be provided to the network computing devices in the system. The security-key may be used to encrypt and decrypt the restoration information. The restoration information may comprise encrypted contents unique to a user registration associated with the user computing device 201 using the security-key. At step 214, the third network computing device 204 may determine information associated with the user computing device 201 based on the received restoration information. When the restoration information is encrypted, the third network computing device 204 may decrypt the restoration information to determine an IMPU or a contact IP address and confirming that the most recent registration of the user computing device 201 is valid (e.g., has not expired, has not been canceled, and/or has not become corrupted). At step 215, for security purposes, the third network computing device 204 may determine that the restoration information is valid. The restoration information may be valid when, for example, it is associated with a valid registration of the user computing device 201. At step 216, the third network computing device 204 may complete processing of the call. The user computing device 201 may also initiate a registration procedure with third network computing device 204 so that subsequent originating calls from the user computing device 201 may then be routed through the third network computing device 204.

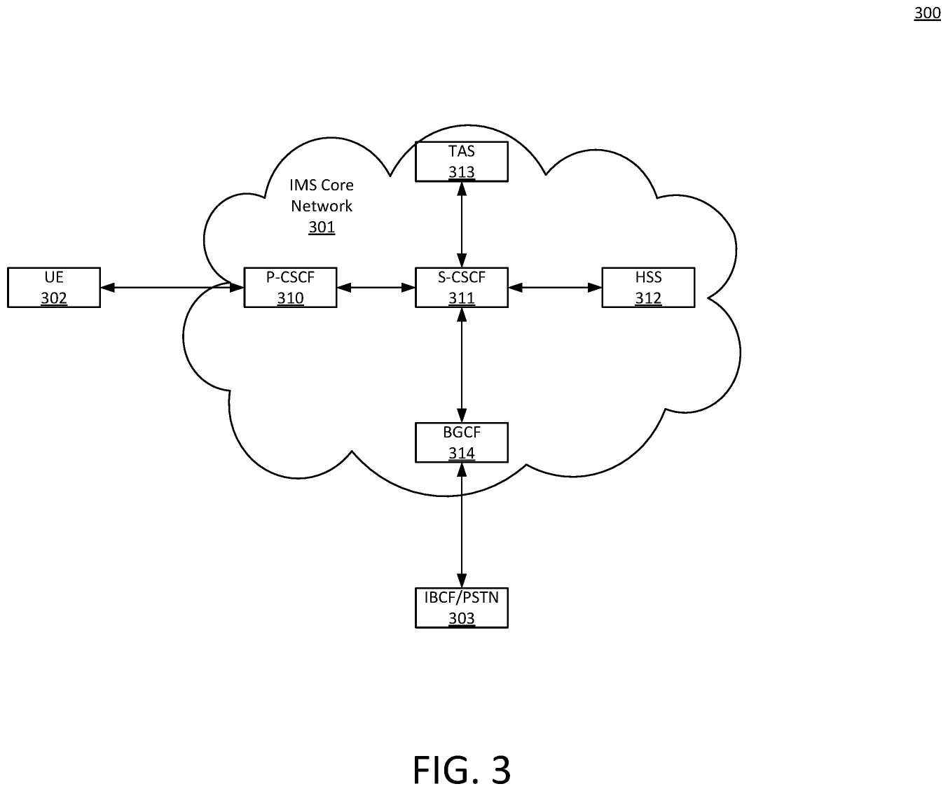

The examples depicted in FIGS. 3-7 described below apply terminology from the Session Initiation Protocol (SIP) and Real-time Transport Protocol (RTP) used in VoIP systems. However, the techniques described herein may be used for and/or applied in other communication systems using any protocol.

FIG. 3 shows an example system 300 for VoIP services. The system 300 may comprise a user equipment (UE) 302. The UE 302 may comprise or be part of a computing device that is configured to provide access, for telephones, to an Internet Protocol (IP) based network. The UE 302 may comprise or be part of a computing device such as an embedded digital voice adapter (EDVA), a cable modem, a gateway device, a VoIP telephone, a smartphone, a desktop computer, a laptop computer, a handheld computer, a tablet, a netbook, a gaming console, a set-top box, or other computing platform. The IP Multimedia Subsystem (IMS) core network 301 may comprise one or more network computing devices configured to route messages through the IMS core network 301 and process VoIP calls. The one or more network computing devices may comprise servers or other computing devices. For example, the IMS core network may comprise a proxy-call session control function (CSCF) (P-CSCF) 310, a serving-CSCF (S-CSCF) 311, a telephony application server (TAS) 313, a home subscriber server (HSS) 312, a breakout gateway control function (BGCF) 314, and an interconnection border control function (IBCF) and a public switched telephone network (PSTN) 303.

The UE 302 may access the IMS core network 301. For example, the UE 302 may access the IMS core network 301 via the P-CSCF 310. The IMS core network 301 may comprise the S-CSCF 311. The S-CSCF 311 may comprise a server or other computing device. The S-CSCF 311 may perform functions such as handling SIP registrations and call routing services. The IMS core network 301 may comprise the HSS 312, which may perform functions such as storing and providing user profile information. The IMS core network 301 may comprise application servers such as the TAS 313 to provide one or more services to users. The one or more functions provided by the TAS 313 may comprise, for example, call forwarding, conference bridging, and voicemail. The IMS core network 301 may comprise the BGCF 314, which may provide routing services. The BGCF 314 may comprise a server or other computing device. The BGCF 314 may route messages to another network to connect a call from the UE 302 to that other network. For example, the BGCF 314 may route messages to another IMS core network or another network via the IBCF and PSTN 303.

A failed call attempt may occur in a VoIP system. For example, as shown in FIG. 3, a failed attempt can occur when a S-CSCF device cannot serve a UE that originated the call. This could happen in scenarios such as the following: (1) the S-CSCF is down either because of a maintenance cycle, a software failure, or a hardware failure; (2) the S-CSCF has a network issue and hence cannot be reached; or (3) the S-CSCF has restarted and hence has lost all the UE registration data.

A very short re-registration interval may be used for restoring failed calls. A short re-registration interval on the UE may reduce the probability that an originating call is made from the UE prior to the UE re-registering. However, a short re-registration interval on the UE does not guarantee that the UE will be successfully registered to a working S-CSCF and that originating calls will complete. Frequent re-registrations generate a large amount of network traffic, resulting in an over-loaded and inefficient system.

Another way to restore failed calls involves informing a UE, using a SIP error response such as SIP 504, that one of the entities along its registration path is not working and that hence the UE needs to perform an initial registration. However, this requires the UE to initiate re-registration upon receipt of a SIP 504 Server Time-out. For some deployments, many UE make/models are not compliant with SIP 504 and do not initiate re-registration upon receipt of SIP 504, thus originating calls continue to fail until the UE re-registers.

Another way to restore failed calls involves an S-CSCF inserting a Service-Route header during initial registration. The Service-Route header may communicate to the P-CSCF the acceptable domain for which calls can be accepted. In the event of failure of the primary S-CSCF, all Non-REGISTER requests would be routed by the P-CSCF to one of the multiple secondary S-CSCF instances as derived from the information in the Service-Route header. The secondary S-CSCF accepts the originating call, performs restoration of the registration info, and routes the call for completion even though the endpoint did not originally register to that specific S-CSCF. However, this requires consistent handling of the SIP Service-Route header between multiple network elements such as the P-CSCF, S-CSCF, and I-CSCF. It is common to use the same vendor and network element to perform both the S-CSCF and I-CSCF network functions, but often the P-CSCF network function is provided by a different vendor. Thus, this limits the voice service provider's vendor options, and therefore in order to leverage this functionality, a voice service provider must select the same vendor for all three network functions: the P-CSCF, the S-CSCF, and the I-CSCF. There is no trust mechanism in this solution as it requires the secondary S-CSCF to implicitly trust the P-CSCF without any validation.

As described above, restoration information may be placed at various network devices in the system. For example, in a VoIP system, restoration information may be proactively placed in S-CSCF computing devices in the system. The restoration information may enable a secondary S-CSCF (or other device in communication with the S-CSCF device) to restore a call when a primary S-CSCF does not respond to a message for call initiation (e.g., following an unreachable event experienced by the primary S-CSCF originally processing the call).

As described above, the restoration information may comprise data associated with a request from the UE to establish a call. The data associated with the request to establish the call may be associated with user registration data so that a secondary S-CSCF may register the UE, connect the call following the an unreachable primary S-CSCF, and connect future calls from that user. The restoration information may be placed in a header. The header may comprise a SIP header. The SIP header may be referred to as a restoration-header. Alternatively, the restoration information may be inserted as a parameter in an existing SIP header (e.g., Route, Contact, From, Restoration-Info, etc.). When the restoration information is encrypted, a security-key may be installed on the P-CSCFs and S-CSCFs in the system.

For example, when a primary S-CSCF does not respond to an originating call (e.g., an unreachable primary S-CSCF), the restoration information may be used by other network computing devices in the system to enable the other devices to restore the call. A P-CSCF may add restoration information (e.g., the restoration-header) to a message used for call initiation (e.g., a SIP invite message) and send the message to a secondary device. The P-CSCF may select the secondary network computing device (e.g., a secondary S-CSCF) for restoring the call using any available mechanism. For example, mechanisms for selecting a secondary network computing device include but are not limited to: a fully qualified domain name (FQDN) of the S-CSCF domain in the service-info header that resolves to multiple S-CSCFs; or a S-CSCF list of primary, secondary, tertiary, etc., elements that are pre-configured in the P-CSCF.

A network computing device may receive the restoration information in the message (e.g., a secondary S-CSCF may receive the SIP invite message) and may validate the restoration information to ensure for security purposes that the call request is associated with a valid user. When the restoration information is encrypted, the secondary S-CSCF may decrypt the encrypted contents using a security-key. For example, the S-CSCF may restore a user profile for completing a call before the call terminates. The S-CSCF may obtain a user profile by initiating a Server-Assignment-Request (SAR) to an HSS and by downloading a user profile. The secondary S-CSCF may continue with call routing and completion. The secondary S-CSCF may then cause the user computing device (e.g., the UE) to register with the secondary S-CSCF following call termination so that the secondary S-CSCF can handle future calls from that UE.

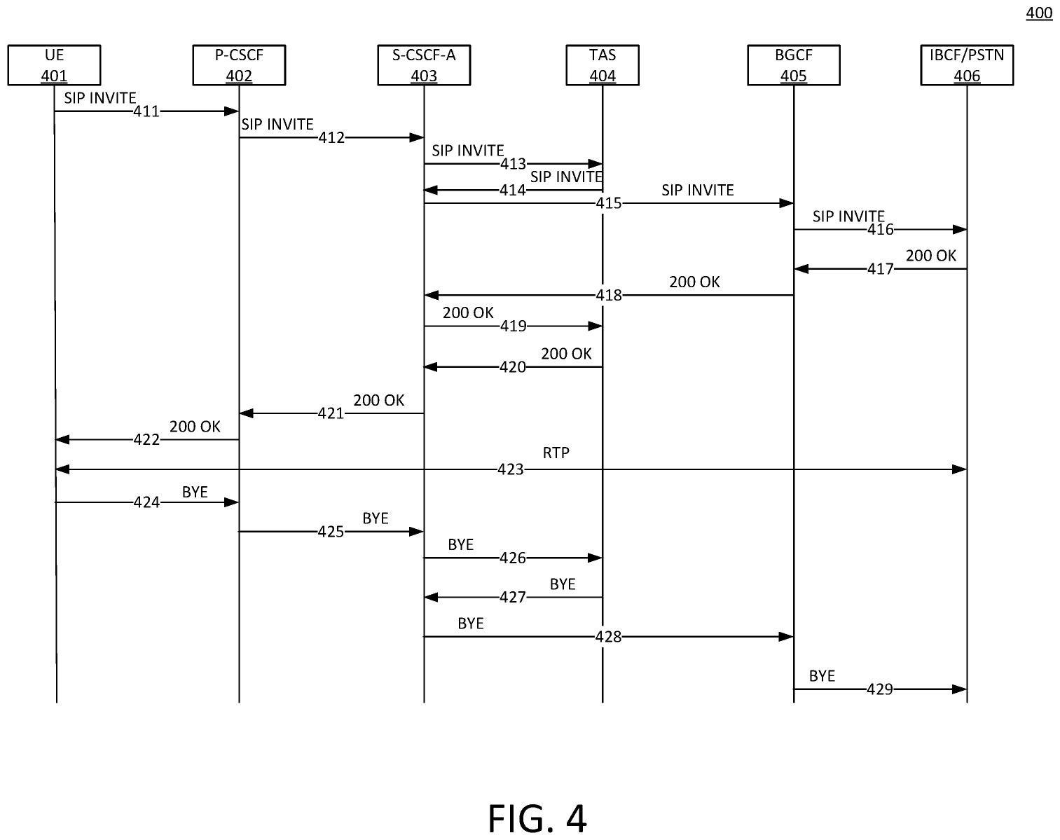

FIG. 4 is an example call flow diagram 400 of an originating call in a VoIP system where the network computing devices are active and operational. In the example in FIG. 4, IMS core network computing devices and SIP and RTP messages and operations are depicted as an example. Some SIP messages may not be depicted to simplify the illustrations. However, as described above, the techniques described herein may be used for and/or applied in other communication systems using any protocol by other computing devices.

At step 411, a UE 401 may send a message comprising a request to establish a call (e.g., a SIP invite message) to a P-CSCF 402. The SIP invite message may be initiated when, for example, a user picks up a telephone connected to the UE 401 and dials digits to initiate a call. At step 412, the P-CSCF 402 may route the SIP invite message to a S-CSCF-A 403, which is the S-CSCF to which the UE is registered. At step 413, the S-CSCF-A 403 may route the SIP invite message to a TAS 404. At step 414, the TAS 404 may send the SIP invite message to the S-CSCF-A 403. At step 415, the S-CSCF-A 403 may send the SIP invite message to a BCGF 405. At step 416, the BGCF 405 may send the SIP invite to an IBCF/PSTN 406. At step 417, the IBCF/PSTN 406 may send a 200 OK message, to the BGCF 405, indicating a successful request and that the call was successfully routed. At step 418, the BGCF 405 may send the 200 OK message to the S-CSCF-A 403. At step 419, the S-CSCF-A 403 may send the 200 OK message to the TAS 404. At step 420, the TAS 404 may send the 200 OK message back to the S-CSCF-A 403. At step 421, the S-CSCF-A 403 may send the 200 OK message to the P-CSCF 402. At step 422, the P-CSCF 402 may send the 200 OK message to the UE 401. At step 423, the call is then connected via RTP. Connecting the call via RTP may comprise, upon receiving the 200 OK, the UE 401 sending a SIP ACK to the 200 OK which is then propagated to the far-end (e.g., the device connected on the far-end of the call).

To disconnect (e.g., tear down) the call, at step 424, the UE 401 may send a BYE message to the P-CSCF 402. At step 425, the P-CSCF 402 may send a BYE message to the S-CSCF-A 403. At step 426, the S-CSCF-A 403 may send a BYE message to the TAS 404. At step 427, the TAS 404 may send a BYE message to the S-CSCF-A 403. At step 428, the S-CSCF-A 403 may send a BYE message to the BGCF 405. At step 429, the BGCF 405 may send a BYE message to the IBCF/PSTN 406. After step 429, the far end may send a 200 OK to the BYE message, which then follows the signaling path to reach the UE 401.

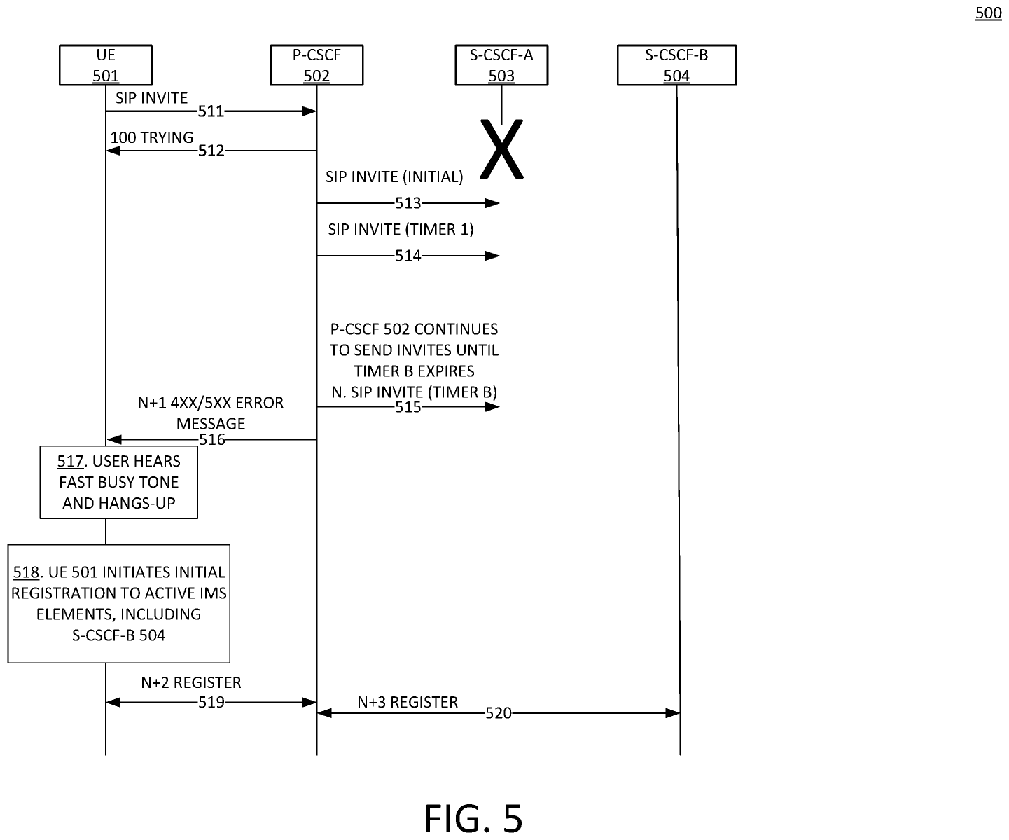

FIG. 5 is an example call flow diagram 500 of a failed originating call attempt in a VoIP system without any originating call restoration technique. In the example in FIG. 5, IMS core network computing devices and SIP and RTP messages and operations are depicted as an example. Some SIP messages may not be depicted to simplify the illustrations. However, as described above, the techniques described herein may be used for and/or applied in other communication systems using any protocol by other computing devices.

At step 511, a UE 501 may send a message comprising a request to establish a call (e.g., a SIP invite message) to a P-CSCF 502 and at the same time may initiate its re-registration timer. The SIP invite message may be initiated when, for example, a user picks up a telephone connected to the UE 501 and dials digits to initiate a call. When the re-registration timer expires, the UE 501 registers with another S-CSCF. At step 512, the P-CSCF 502 may send a 100 TRYING message to the UE 501 to confirm that it is attempting to connect the call. At step 513, the P-CSCF 502 may initiate a timer send an initial SIP invite message to a S-CSCF-A 503, which is the S-CSCF to which the UE is registered. When the timer initiated by the P-CSCF 502 expires, the P-CSCF 502 considers the S-CSCF-A 503 to be unreachable (e.g., an unreachable event occurred). At step 514, the P-CSCF 502 may send another SIP invite message to the S-CSCF-A 503. At step 515, P-CSCF 502 may continue sending N SIP invite messages until its timer expires. At step 516, P-CSCF 502 may send an error message (e.g., an N+1 4XX/5XX Error Message) to the UE 501 to indicate that the call failed. In this scenario, for the period following the S-CSCF-A 503 failure but before the UE's 501 re-registration timer expires, the user's first originating call attempt has failed (steps 511 through 516).

Following the call failure, at step 517, the user may hear a fast busy tone and may hang up. At step 518, the UE 501 may initiate an initial registration with active IMS elements such as, for example, S-CSCF-B 504 and then successfully registers to a secondary S-CSCF. At step 519, the UE 501 and the P-CSCF 502 may exchange N+2 REGISTER messages to perform the UE 501 registration. At step 520, the P-CSCF 502 and the S-CSCF-B 504 may exchange N+3 REGISTER messages to complete the UE 501 registration. At this point, the user is able to originate a call that can complete through S-CSCF-B 504.

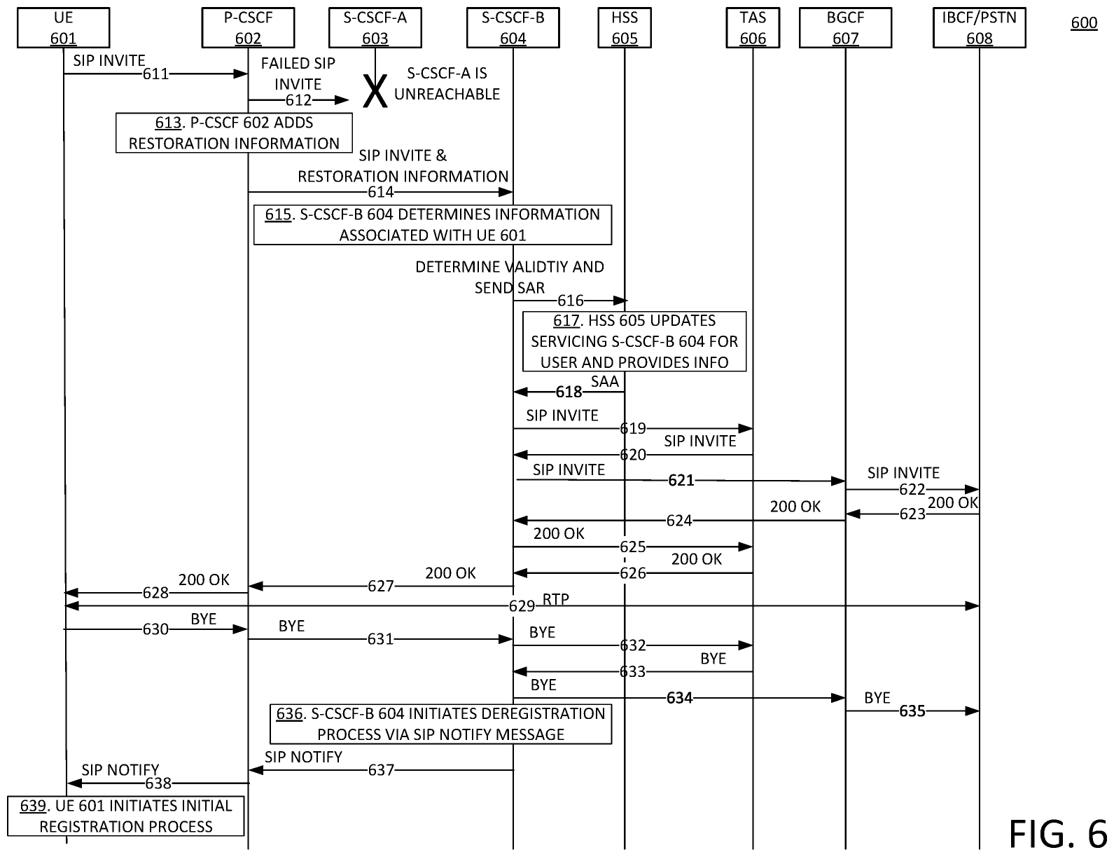

FIG. 6 is an example call flow diagram 600 showing an originating call being restored using the restoration techniques described herein applied to a VoIP system. An enhanced IMS P-CSCF and S-CSCF may be used to restore voice service to a UE that is requesting a call to be connected without having to be registered with the S-CSCF restoring the call. In the example in FIG. 6, IMS core network computing devices and SIP and RTP messages and operations are depicted as an example. Some SIP messages may not be depicted to simplify the illustrations. However, as described above, the techniques described herein may be used for and/or applied in other communication systems using any protocol by other computing devices.

At step 611, a UE 601 may send a message comprising a request to establish a call (e.g., a SIP invite message) to a P-CSCF 602. The SIP invite message may be initiated when, for example, the user picks up a telephone connected to the UE 601 and dials digits to initiate a call. At step 612, the P-CSCF 602 may route the SIP invite message to a S-CSCF-A 603, which is the S-CSCF to which the UE is registered. However, in this example, S-CSCF-A 603 is unreachable, and the SIP invite message sent from the P-CSCF 602 to the S-CSCF-A 603 fails. The P-CSCF 602 may determine that S-CSCF-A 603 is unreachable (e.g., this may be indicated when the S-CSCF-A 603 does not provide a SIP 100 Trying response to the SIP invite).

In accordance with the techniques described herein, at step 613, the P-CSCF 602 may send restoration information to network computing devices in the system. The restoration information may be inserted by the P-CSCF 602 into a header (e.g., a restoration-header) in the SIP invite message. As described above, at least a portion of the restoration information may be optionally encrypted. When the restoration information is encrypted, prior to call initiation, a voice service provider may install a security-key on the network computing devices in the system (e.g., the P-CSCF 602, the S-CSCF-A 603, and S-CSCF-B 604). The restoration information may optionally comprise encrypted contents unique to the user's current registration using the security-key that is stored on the network computing devices in the system (e.g., the S-CSCF-A 603 and a S-CSCF-B 604). For example, the security-key is installed on the S-CSCFs (e.g., the S-CSCF-A 603 and a S-CSCF-B 604) and can be used to encrypt/decrypt the contents of the restoration-header. The security-key may be used to encrypt and decrypt the restoration information (e.g., the contents of a restoration-header or another SIP header comprising the contents of a restoration-header).

At step 614, the P-CSCF 602 may send the SIP invite comprising the restoration information to another network computing device in the system (e.g., the S-CSCF-B 604). Selection mechanisms for the network computing devices (e.g., selection of the S-CSCFs) may include techniques including but not limited to the following: a FQDN of the S-CSCF domain in the service-info header that resolves to multiple S-CSCFs; or a S-CSCF list of primary, secondary, tertiary, etc., elements that are pre-configured in the P-CSCF 602.

At step 615, the S-CSCF-B 604 may determine information associated with the UE 601 based on the received restoration information. The information associated with the user may comprise registration information. When the restoration information is encrypted, the S-CSCF-B 604 may decrypt the restoration information to determine an IMPU or a contact IP address and confirming that the most recent registration of the UE 601 was valid (i.e., within the current registration window). At step 616, for security the S-CSCF-B 604 may determine that the restoration information is valid and may send a SAR to an HSS 605. The restoration information may be valid when, for example, it is associated with a valid registration of UE 601. If the S-CSCF-B determines that decrypted contents are not valid, the SIP invite may be rejected.

At step 617, the HSS 605 may update the serving S-CSCF-B 604 for the user and provide additional user information that was not included in the restoration information. At step 618, the HSS 605 may send a Server-Assignment-Answer (SAA) to the S-CSCF-B 604.

The call may then complete and terminate. At step 619, the S-CSCF-B 604 may send the SIP invite message to a TAS 606. At step 620, the TAS 606 may send the SIP invite message to the S-CSCF-B 604. At step 621, the S-CSCF-B 604 may send the SIP invite message to a BCGF 607. At step 622, the BGCF 607 may send the SIP invite to an IBCF/PSTN 608. At step 623, the IBCF/PSTN 608 may send a 200 OK message, to the BGCF 607, indicating a successful request. At step 624, the BGCF 607 may send the 200 OK message to the S-CSCF-B 604. At step 625, the S-CSCF-B 604 may send the 200 OK message to the TAS 606. At step 626, the TAS 606 may send the 200 OK message back to the S-CSCF-B 604. At step 627, the S-CSCF-B 604 may send the 200 OK message to the P-CSCF 602. At step 628, the P-CSCF 602 may send the 200 OK message to the UE 601. At step 629, the call is then connected via RTP.

To disconnect (e.g., tear down) the call, at step 630, the UE 601 may send a BYE message to the P-CSCF 602. At step 631, the P-CSCF 602 may send a BYE message to the S-CSCF-B 604. At step 632, the S-CSCF-B 604 may send a BYE message to the TAS 606. At step 633, the TAS 606 may send a BYE message to the S-CSCF-B 604. At step 634, the S-CSCF-B 604 may send a BYE message to the BGCF 607. At step 635, the BGCF 607 may send a BYE message to the IBCF/PSTN 608.

At step 636, following completion of the call, as registration of the UE 601 with the S-CSCF-B 604 did not occur via a normal process, the S-CSCF-B 604 may initiate a deregistration process via a SIP NOTIFY message. At step 637, the S-CSCF-B 604 may send the SIP NOTIFY message to the P-CSCF 602. The SIP NOTIFY message may comprise a SIP header Subscription-State set to terminated and reason set to timeout. At step 638, the P-CSCF 602 may send the SIP notify message to the UE 601. Following receipt of the SIP NOTIFY with SIP header Subscription-State set to terminated, at step 639, the UE 601 may initiate an initial registration, which the P-CSCF 602 may steer towards the S-CSCF-B 604 because the S-CSCF-A 603 has been unreachable and may still be unreachable. Subsequent originating calls from the UE 601 may then be routed through the S-CSCF-B 604 in accordance with the procedure of FIG. 4.

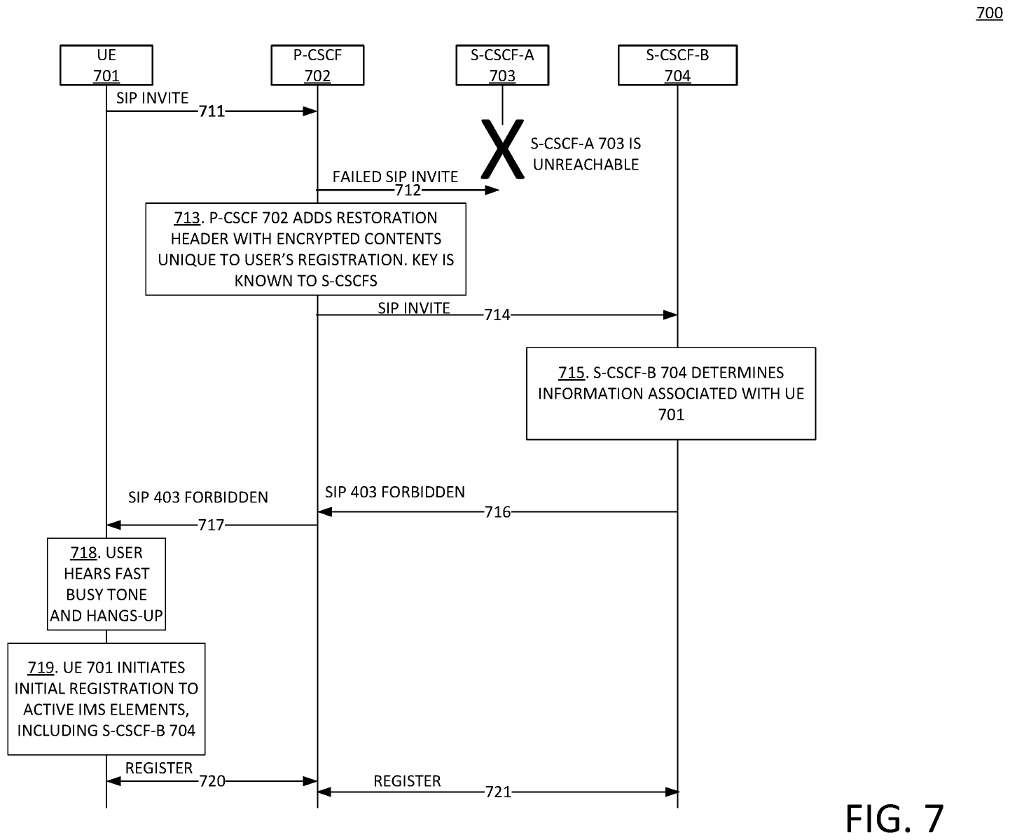

FIG. 7 is an example call flow diagram 700 showing an originating call in a VoIP system with the restoration techniques described herein enabled, but the contents of the restoration information are invalid. For example, if the restoration information is encrypted, the security key may be invalid. In the example in FIG. 7, IMS core network computing devices and SIP and RTP messages and operations are depicted as an example. Some SIP messages may not be depicted to simplify the illustrations. However, as described above, the techniques described herein may be used for and/or applied in other communication systems using any protocol by other computing devices.

At step 711, a UE 701 may send a message comprising a request to establish a call (e.g., a SIP invite message) to a P-CSCF 702. The SIP invite message may be initiated when, for example, the user picks up a telephone connected to the UE 701 and dials digits to initiate a call. At step 712, the P-CSCF 702 may route the SIP invite message to a S-CSCF-A 703, which is the S-CSCF to which the UE is registered. However, in this example, S-CSCF-A 703 is unreachable, and the SIP invite message sent from the P-CSCF 702 to the S-CSCF-A 703 fails. The P-CSCF 702 may determine that S-CSCF-A 703 is unreachable (e.g., this may be indicated when the S-CSCF-A 703 does not provide a SIP 100 Trying response to the SIP invite).

In accordance with the techniques described herein, at step 713, the P-CSCF 702 may send restoration information to network computing devices in the system. The restoration information may be inserted by the P-CSCF 702 into a header (e.g., a restoration-header) in the SIP invite message. As described above, at least a portion of the restoration information may be optionally encrypted. When the restoration information is encrypted, prior to call initiation, a voice service provider may install a security-key on the network computing devices in the system (e.g., the P-CSCF 702, the S-CSCF-A 703, and S-CSCF-B 704 depicted in FIG. 7). The security-key may be used to encrypt and decrypt the restoration information (e.g., the contents of a restoration-header or another SIP header comprising the contents of a restoration-header as described herein). The restoration information may comprise encrypted contents unique to the user's current registration using the security-key that is stored on the network computing devices in the system (e.g., the S-CSCF-A 703 and a S-CSCF-B 704). For example, the security-key is installed on the S-CSCFs (e.g., the S-CSCF-A 703 and a S-CSCF-B 704) and can be used to encrypt/decrypt the contents of the restoration-header.

At step 714, the P-CSCF 702 may send the SIP invite comprising the restoration information to another network computing device in the system (e.g., the S-CSCF-B 704). Selection mechanisms for a S-CSCF-B 704 may include techniques including but not limited to the following: a FQDN of the S-CSCF domain in the service-info header that resolves to multiple S-CSCFs; or a S-CSCF list of primary, secondary, tertiary, etc., elements that are pre-configured in the P-CSCF 702.

At step 715, the S-CSCF-B 704 may determine information associated with the UE 701 based on the received restoration information. The information associated with the user may comprise registration information. When the restoration information is encrypted, the S-CSCF-B 704 may decrypt the restoration information to determine an IMPU or a contact IP address and confirming that the most recent registration of the UE 401 was valid (i.e., within the current registration window). At step 716, the S-CSCF-B 704 may determine that the restoration information is not valid. The restoration information may not be valid because it is corrupted or not associated with a registered UE. If the restoration information was encrypted, the security key may have been determined to be invalid. Because the restoration information is invalid, for security purposes, the S-CSCF-B 704 may reject the SIP invite and send a SIP 403 Forbidden message to the P-CSCF 702. At step 717, the P-CSCF 702 may send a SIP 403 Forbidden message to the UE 701 and the call fails.

Following the call failure, at step 718, the user may hear a fast busy tone and may hang up. At step 719, the UE 701 may initiate an initial registration with active IMS elements such as, for example, S-CSCF-B 704. At step 720, the UE 701 and the P-CSCF 702 may exchange REGISTER messages. At step 721, the P-CSCF 702 and the S-CSCF-B 704 may exchange REGISTER messages. Subsequent originating calls from the UE 701 may be routed through the S-CSCF-B 704.

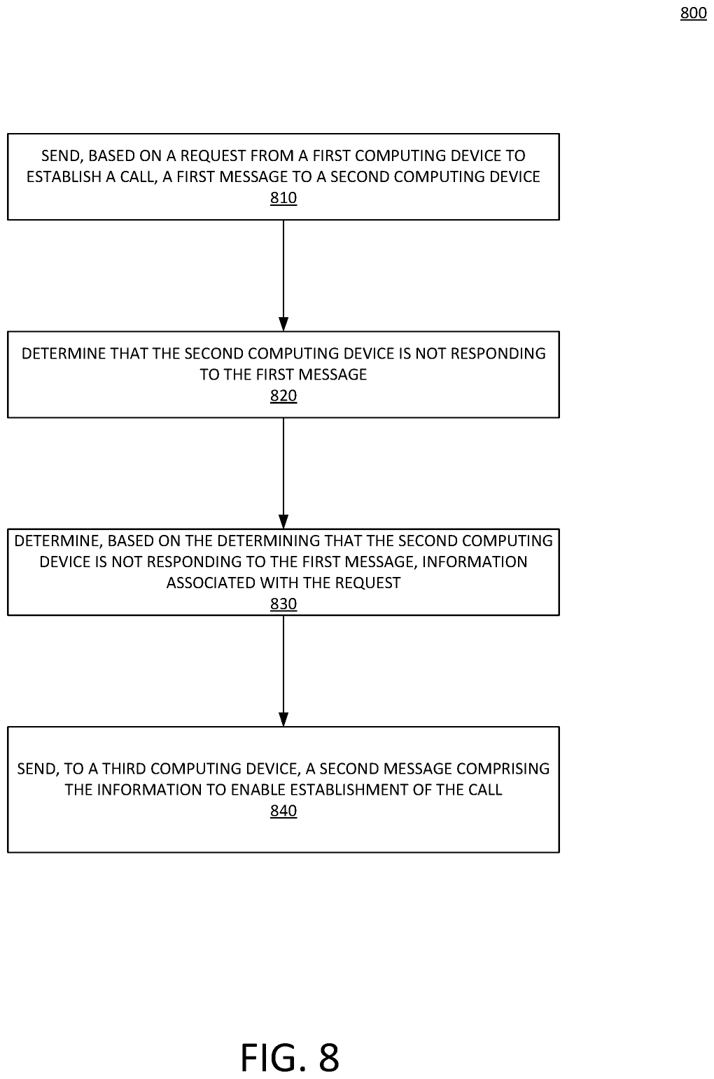

FIG. 8 shows an example method 800. The method 800 of FIG. 8, may be performed by any of the devices depicted in FIGS. 1-7. While each step in the method 800 of FIG. 8 is shown and described separately, multiple steps may be executed in a different order than what is shown, in parallel with each other, or concurrently with each other. At step 810, a first message may be sent, based on a request from a first computing device to establish a call, to a second computing device. The first computing device may comprise a UE. The second computing device may comprise a network computing device. The network computing device may comprise a computing device in a VoIP system such as an S-CSCF.

At step 820, it may be determined that the second computing device is not responding. The second computing device may not be responding to the first message because the second computing device is unreachable. At step 830, information associated with the request may be determined based on the determining that second computing device is not responding to the first message. The information may indicate user registration data. The user registration data may indicate timing information indicating at least one of when a user registered or an amount of time that the user registration data is valid.

At step 840, a second message, comprising the information to enable establishment of the call, may be sent to a third computing device. The third computing device may be determined based on at least one selection mechanism. The at least one selection mechanism may comprise at least one of an FQDN of the third computing device that is included in a header of the first message or a list. The third computing device may comprise a network computing device. The network computing device may comprise a computing device in a VoIP system such as an S-CSCF.

The second message may comprise a SIP message. The SIP message may comprise a header that comprises the information. At least a portion of the information may be encrypted. A security key may be accessible to the third computing device. The security key may be based on at least one of: symmetric encryption and is accessible by third computing device, asymmetric encryption based on a public and private key combination, or a JWT.

A third message indicating that the call is established may be received. The third message may be received based on the information being valid. The information may comprise at least one of an IMPU, a contact IP address, or registration information associated with the first computing device.

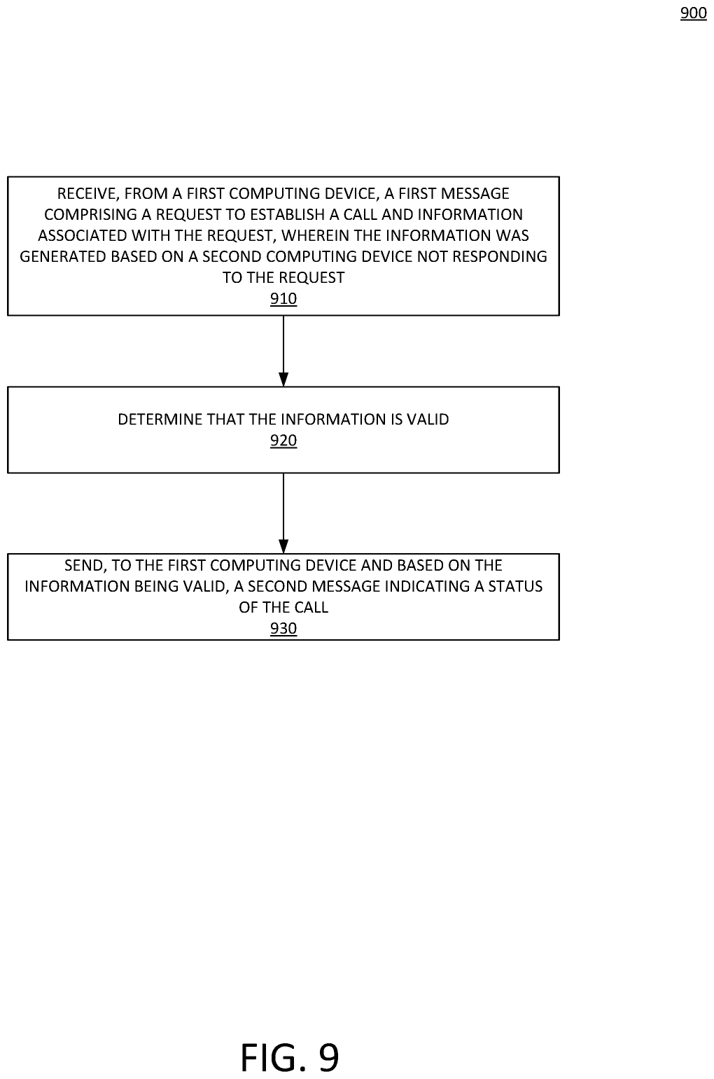

FIG. 9 shows an example method 900. The method 900 of FIG. 9, may be performed by any of the devices depicted in FIGS. 1-7. While each step in the method 900 of FIG. 9 is shown and described separately, multiple steps may be executed in a different order than what is shown, in parallel with each other, or concurrently with each other. At step 910, a first message comprising a request to establish a call and information associated with the request, wherein the information was generated based on a second computing device not responding to the request may be received. The information may comprise at least one of an IMPU, a contact IP address, or registration information associated with the first computing device.

The first message may comprise a SIP message. The SIP message may comprise a header that comprises the information. At least a portion of the information may be encrypted. A security key may be accessible for decrypting the information. The security key may be based on at least one of: symmetric encryption and is shared by network computing devices in the system, asymmetric encryption based on a public and private key combination, or a JWT. At step 920, the information may be determined to be valid. At step 930, a second message indicating a status of the call may be sent to the first computing device and based on the information being valid.

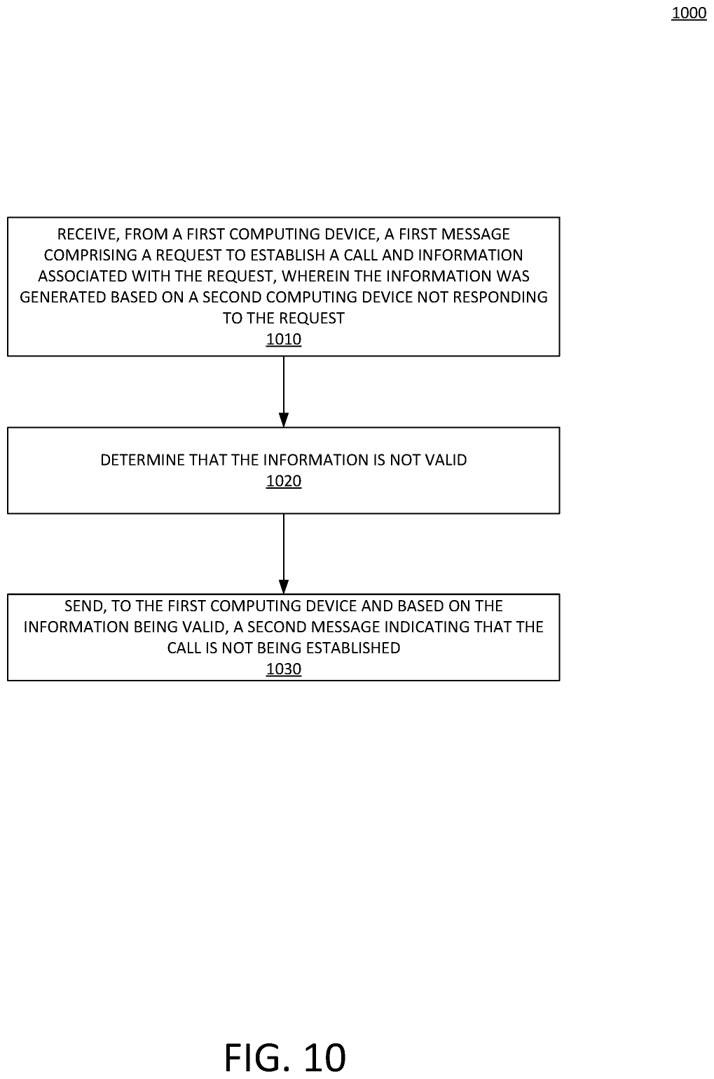

FIG. 10 shows an example method 1000. The method 1000 of FIG. 10, may be performed by any of the devices depicted in FIGS. 1-7. While each step in the method 1000 of FIG. 10 is shown and described separately, multiple steps may be executed in a different order than what is shown, in parallel with each other, or concurrently with each other. At step 1010, a first message comprising a request to establish a call and information associated with the request, wherein the information was generated based on a second computing device not responding to the request may be received. The information may comprise at least one of an IMPU, a contact IP address, or registration information associated with the first computing device.

The first message may comprise a SIP message. The SIP message may comprise a header that comprises the information. At least a portion of the information may be encrypted. A security key may be accessible to the one or more third computing devices. The security key may be based on at least one of: symmetric encryption and is shared by network computing devices in the system, asymmetric encryption based on a public and private key combination, or a JWT. At step 1020, the information may be determined to not be valid. At step 1030, a second message indicating that the call is not being established may be sent to the first computing device and based on the information not being valid.

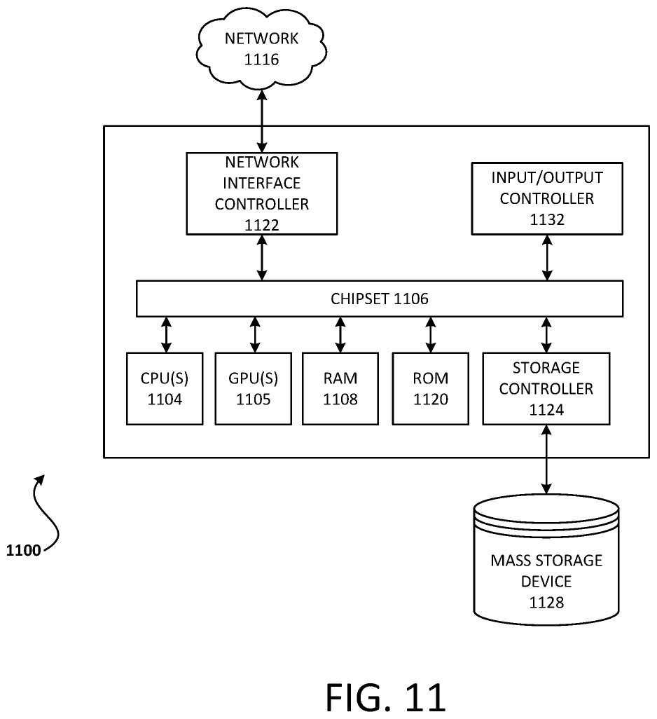

FIG. 11 depicts a computing device 1100 that may be used in various aspects, such as the servers, modules, and/or devices depicted in FIGS. 1-7. With regard to the examples of FIGS. 1-7, the devices may each be implemented in an instance of a computing device 1100 of FIG. 11. The computer architecture shown in FIG. 11 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIGS. 1-2 and 4-10.

The computing device 1100 may include a baseboard, or “motherboard,” which is a printed circuit board to which a multitude of components or devices may be connected by way of a system bus or other electrical communication paths. One or more central processing units (CPUs) 1104 may operate in conjunction with a chipset 1106. The CPU(s) 1104 may be standard programmable processors that perform arithmetic and logical operations necessary for the operation of the computing device 1100.

The CPU(s) 1104 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1104 may be augmented with or replaced by other processing units, such as GPU(s) 1105. The GPU(s) 1105 may comprise processing units specialized for but not necessarily limited to highly parallel computations, such as graphics and other visualization-related processing.

A chipset 1106 may provide an interface between the CPU(s) 1104 and the remainder of the components and devices on the baseboard. The chipset 1106 may provide an interface to a random access memory (RAM) 1108 used as the main memory in the computing device 1100. The chipset 1106 may further provide an interface to a computer-readable storage medium, such as a read-only memory (ROM) 1120 or non-volatile RAM (NVRAM) (not shown), for storing basic routines that may help to start up the computing device 1100 and to transfer information between the various components and devices. ROM 1120 or NVRAM may also store other software components necessary for the operation of the computing device 1100 in accordance with the aspects described herein.

The computing device 1100 may operate in a networked environment using logical connections to remote computing nodes and computer systems through local area network (LAN) 1116. The chipset 1106 may include functionality for providing network connectivity through a network interface controller (NIC) 1122, such as a gigabit Ethernet adapter. A NIC 1122 may be capable of connecting the computing device 1100 to other computing nodes over a network 1116. It should be appreciated that multiple NICs 1122 may be present in the computing device 1100, connecting the computing device to other types of networks and remote computer systems.

The computing device 1100 may be connected to a mass storage device 1128 that provides non-volatile storage for the computer. The mass storage device 1128 may store system programs, application programs, other program modules, and data, which have been described in greater detail herein. The mass storage device 1128 may be connected to the computing device 1100 through a storage controller 1124 connected to the chipset 1106. The mass storage device 1128 may consist of one or more physical storage units. A storage controller 1124 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1100 may store data on a mass storage device 1128 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1128 is characterized as primary or secondary storage and the like.

For example, the computing device 1100 may store information to the mass storage device 1128 by issuing instructions through a storage controller 1124 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1100 may further read information from the mass storage device 1128 by detecting the physical states or characteristics of one or more particular locations within the physical storage units.

In addition to the mass storage device 1128 described herein, the computing device 1100 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1100.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1128 depicted in FIG. 11, may store an operating system utilized to control the operation of the computing device 1100. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1128 may store other system or application programs and data utilized by the computing device 1100.

The mass storage device 1128 or other computer-readable storage media may also be encoded with computer-executable instructions, which, when loaded into the computing device 1100, transforms the computing device from a general-purpose computing system into a special-purpose computer capable of implementing the aspects described herein. These computer-executable instructions transform the computing device 1100 by specifying how the CPU(s) 1104 transition between states, as described herein. The computing device 1100 may have access to computer-readable storage media storing computer-executable instructions, which, when executed by the computing device 1100, may perform the methods described in relation to FIGS. 1-2 and 4-10.

A computing device, such as the computing device 1100 depicted in FIG. 11, may also include an input/output controller 1132 for receiving and processing input from a number of input devices, such as a keyboard, a mouse, a touchpad, a touch screen, an electronic stylus, or other type of input device. Similarly, an input/output controller 1132 may provide output to a display, such as a computer monitor, a flat-panel display, a digital projector, a printer, a plotter, or other type of output device. It will be appreciated that the computing device 1100 may not include all of the components shown in FIG. 11, may include other components that are not explicitly shown in FIG. 11, or may utilize an architecture completely different than that shown in FIG. 11.

As described herein, a computing device may be a physical computing device, such as the computing device 1100 of FIG. 11. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems described herein are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed:

1. A method comprising:
sending, based on a request from a first computing device to establish a call, a first message to a second computing device;
determining that the second computing device is not responding to the first message;
determining, based on the determining that second computing device is not responding to the first message, information associated with the request; and
sending, to a third computing device, a second message comprising the information to enable establishment of the call.

2. The method of claim 1, wherein the second message comprises a Session Initiation Protocol (SIP) message.

3. The method of claim 2, wherein the SIP message comprises a header that comprises the information.

4. The method of claim 1, wherein the information indicates user registration data, wherein the user registration data indicates timing information indicating at least one of when a user registered or an amount of time that the user registration data is valid.

5. The method of claim 1, wherein at least a portion of the information is encrypted and a security key is accessible to the third computing device, wherein the security key is based on at least one of: symmetric encryption and is shared by the one or more third computing devices, asymmetric encryption based on a public and private key combination, or a Java web token (JWT).

6. The method of claim 1, wherein the determining that the second computing device is not responding to the first message indicates that the second computing device is unreachable.

7. The method of claim 1, wherein the third computing device is determined based on at least one selection mechanism, wherein the at least one selection mechanism comprises at least one of a fully qualified domain name (FQDN) of the third computing device that is included in a header of the first message or a list.

8. The method of claim 1, further comprising:
receiving, from the third computing device, a third message indicating that the call is established.

9. The method of claim 8, wherein the receiving the third message is based on the information being valid.

10. The method of claim 9, wherein the information comprises at least one of an Internet Protocol (IP) Multimedia Public Identity (IMPU), a contact IP address, or registration information associated with the first computing device.

11. A method comprising:
receiving, from a first computing device, a first message comprising a request to establish a call and information associated with the request, wherein the information was generated based on a second computing device not responding to the request;
determining that the information is valid; and
sending, to the first computing device and based on the information being valid, a second message indicating a status of the call.

12. The method of claim 11, wherein the information comprises at least one of an Internet Protocol (IP) Multimedia Public Identity (IMPU), a contact IP address, or registration information associated with a third computing device.

13. The method of claim 11, wherein the first message comprises a Session Initiation Protocol (SIP) message.

14. The method of claim 13, wherein the SIP message comprises a header that comprises the information.

15. The method of claim 11, further comprising:
receiving, from the first computing device, a security key, and wherein at least a portion of the information is encrypted and the security key is usable to decrypt the information, wherein the security key is based on at least one of: symmetric encryption, asymmetric encryption based on a public and private key combination, or a Java web token (JWT).

16. A method comprising:
receiving, from a first computing device, a first message comprising a request to establish a call and information associated with the request, wherein the information was generated based on a second computing device not responding to the request;
determining that the information is not valid; and
sending, to the first computing device and based on the information not being valid, a second message indicating that the call is not being established.

17. The method of claim 16, wherein the information comprises at least one of an Internet Protocol (IP) Multimedia Public Identity (IMPU), a contact IP address, or registration information associated with a third computing device.

18. The method of claim 16, wherein the first message comprises a Session Initiation Protocol (SIP) message.

19. The method of claim 18, wherein the SIP message comprises a header that comprises the information.

20. The method of claim 16, further comprising:
receiving, from the first computing device, a security key, and wherein at least a portion of the information is encrypted and the security key is usable to decrypt the information, wherein the security key is based on at least one of: symmetric encryption, asymmetric encryption based on a public and private key combination, or a Java web token (JWT).
